(19) United States
(12) Patent Application Publication
(10) Pub. No.: US 2010/0235294 A1
(43) Pub. Date: Sep. 16, 2010

(54) System and Methods for Multi-Dimension Top Down Negotiation

(76) Inventors: Sri Raghupathy, San Jose, CA (US); Derrick Keller Herbst, Lexington, SC (US); Yvonne K. Baur, Palo Alto, CA (US)

Correspondence Address: KANG LIM, 3494 CAMINO TASSAJARA ROAD #436, DANVILLE, CA, 94506, US

(21) Appl. No.: 12/726,235

(22) Filed: Mar. 17, 2010

Related U.S. Application Data
(63) Continuation-in-part of application No. 11/193,313, filed on Jul. 30, 2005.

(51) Int. Cl. G06Q 10/00

(52) U.S. Cl. 705/342; 705/348

(57) ABSTRACT

The present invention relates to systems and methods for multi-dimensional top down negotiations. A user supplies negotiated deal dimensions to an allocator. The allocator may also be able to set some of the dimension values to a default value. A line item generator may then perform transformational algorithms on the negotiated deal dimensions to generate line items. A line item override module may then receive user overrides for specific line items, and update the line items using the overrides. This update may include the recalculating of other line items affected by the override. A summarizer may generate a deal summary using the updated line items. A normalization engine may also normalize the deal summary to current market value to facilitate comparisons of the deal summary. The deal summary may include any of a blended rate per hour, an income, a cost, a product margin, and a net present value. Further, the deal summary may be broken down by geography, period and resource type.

### RELATED APPLICATIONS

This application is a continuation-in-part of U.S. patent application Ser. No. 11/193,313 filed on Jul. 30, 2005 by Shannon Y. Zhang, Simon C. Lee and Sri Raghupathy, entitled “Systems and Methods for Tiered-Pricing in a Price Management System”. The content of that application is incorporated herein by reference.

This application is related to co-pending and concurrently filed application Ser. No. ______, filed Mar. 17, 2010, by Derrick Keller Herbst, Sri Raghupathy, Sastry Kolachana and Ramesh Seshadri, entitled “System and Methods for Multiple Pricing Comparison” which application is incorporated herein in its entirety by this reference.

### BACKGROUND

The present invention relates to business to business market price control and management systems. More particularly, the present invention relates to systems and methods for multi-dimensional top down negotiations in order to facilitate the optimizing of prices in a business to business market setting wherein an optimal price change is determined according to business strategy and objectives.

There are major challenges in Business to Business (hereinafter “B2B”) markets which hinder the effectiveness of classical approaches to price setting. These classical approaches to price setting typically rely upon databases of extensive transaction data which may then be modeled for demand. The effectiveness of classical price setting approaches depends upon a rich transaction history where prices have changed, and consumer reactions to these price changes are recorded. Thus, classical price setting approaches work best where there is a wide customer base and many products, such as in Business to Consumer (hereinafter “B2C”) settings.

Unlike B2C environments, in B2B markets a small number of customers represent the lion's share of the business. Managing the prices of these key customers is where most of the pricing opportunity lies. Also, B2B markets are renowned for being data-poor environments. Availability of large sets of accurate and complete historical sales data is scarce.

Furthermore, B2B environments suffer from poor customer segmentation. Historical sales usually exhibit minor price changes for each customer. Furthermore, price bands within customer segments are often too large and customer behavior within each segment is non-homogeneous.

Product or segment price optimization relies heavily on the quality of the customer segmentation and the availability of accurate and complete sales data. In this context, price optimization makes sense only (i) when price behavior within each customer segment is homogeneous and (ii) in the presence of data-rich environments where companies sales data and their competitors' prices are readily available. These conditions are met almost exclusively in B2C markets such as retail, and are rarely encountered in B2B markets.

On the other hand, customer price optimization relies heavily on the abundance of data regarding customers' past behavior and experience, including win/loss data and customer price sensitivity. Financial institutions have successfully applied customer price optimization in attributing and setting interest rates for credit lines, mortgages and credit cards. Here again, the aforementioned condition is met almost exclusively in B2C markets.

Finally, B2B markets are characterized by deal negotiations instead of non-negotiated sale prices (prevalent in business to consumer markets). There is no existing literature on optimization of negotiation terms and processes, neither at the product/segment level nor at the customer level.

Negotiation of terms and processes has historically been a skill entirely dependent upon the salesperson. Recent advances in negotiation software have enabled the negotiation process to be performed in a more consistent manner; however, deal term negotiation still remains more of an ‘art’. Part of the reason deal negotiation is inconsistent is that the amount of data involved in a typical B2B deal is very large. Further, a number of deal specifics are often unknown. The negotiating parties must estimate values for these unknown specifics and synthesize large amounts of information in order to negotiate favorable deal terms.

Due to the difficulties inherent in a B2B negotiation environment, there is a strong need for a system able to provide guidance for deal negotiations which minimizes the guesswork inherent to B2B negotiations. Such a system would enable an executive view of pricing negotiations in order to facilitate globally favorable negotiation outcomes.

In view of the foregoing, System and Methods for multi-dimensional top down negotiations are disclosed. The present invention provides a novel system for the generation of deal term line items which may be generated automatically. This system enables the user to maintain an executive view of the negotiations, with product and resource allocations made at high levels. Guesswork on the user's part is reduced, and a summary view is produced for the user to aid in the negotiation process.

### SUMMARY

The present invention discloses business to business market price control and management systems. More particularly, the present invention teaches systems and methods for multi-dimensional top down negotiations. Such a system may automatically generate line item data for a given deal given high level resource allocation input. The line item data may be presented to the user in a deal summary view which may then be leveraged to facilitate favorable negotiations of deal terms.

In some embodiments of the present invention, a user supplies one or more negotiated deal dimensions to an allocator. These negotiated deal dimensions may include one or more of total resources, period allocation, regional distribution, skill set distribution, inflation rates, and billing hours, in some embodiments. Of course, additional or different dimensions may be negotiated and utilized in some embodiments of the invention. Additionally, in some embodiments, the allocator may be configured to set one or more of the dimension values to a default. This default may be preloaded within the system, or may include a look up of the value from a known index, or industry standard.

A line item generator may then, in some embodiments, perform transformational algorithms on the negotiated deal dimensions in order to generate a listing of line items. Line item values may be presented to the user for review and updating. A line item override module may then receive user overrides for specific line items. The line item override module may likewise update the line items using the overrides, in these embodiments. This update may include the recalculating of other line items affected by the override.

After updating, a summarizer may generate a deal summary using the updated line items. In some embodiments, a normalization engine may first normalize the deal summary to current market value to facilitate comparisons of the deal summary.

The deal summary may, in some embodiments, include any of a blended rate per hour, an income, a cost, a product margin, and a net present value. Further, the deal summary may be broken down by geography, period and resource type, in some embodiments.

Note that the various features of the present invention described above can be practiced alone or in combination. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 provides an example block diagram for a negotiation system in accordance with an embodiment of the present invention;

FIG. 2 provides an example block diagram of the multi-dimensional top down negotiator in accordance with an embodiment of the present invention;

FIG. 3 provides an example block diagram of the resource and product allocator in accordance with an embodiment of the present invention;

FIG. 4 provides an example flow chart for the negotiation process using the multi-dimensional top down negotiator in accordance with an embodiment of the present invention;

FIG. 5 provides an example flow chart for the specification of dimension values in accordance with an embodiment of the present invention;

FIG. 6 provides an example screenshot of a listing of all top down deals in accordance with an embodiment of the present invention;

FIGS. 7A and 7B provide example screenshots of the header for a top down deal in accordance with an embodiment of the present invention;

FIGS. 8A to 8C provide example screenshots of terms for a top down deal in accordance with an embodiment of the present invention;

FIG. 9 provides an example screenshot of the generated line items for a top down deal in accordance with an embodiment of the present invention;

FIG. 10 provides an example screenshot of the override tool for line items of the top down deal in accordance with an embodiment of the present invention;

FIG. 11 provides an example screenshot of the deal summary for the top down deal in accordance with an embodiment of the present invention;

FIG. 12 provides a first example block diagram of a pricing comparison system in accordance with an embodiment of the present invention;

FIG. 13 provides a second example block diagram of a pricing comparison system in accordance with an embodiment of the present invention;

FIG. 14 provides an example block diagram of a multiple pricing comparator in accordance with an embodiment of the present invention;

FIG. 15 provides an example flow chart for the process of comparing pricing methods in accordance with an embodiment of the present invention;

FIG. 16 provides an example screenshot of a header for the multiple pricing comparison in accordance with an embodiment of the present invention;

FIGS. 17A and 17B provide example screenshots of a time and material agreement for the multiple pricing comparison in accordance with an embodiment of the present invention;

FIGS. 18 and 19 provide example screenshots for the conversion of a quote for the multiple pricing comparison in accordance with an embodiment of the present invention;

FIG. 20 provides an example screenshot of a fixed type quote conversion for the multiple pricing comparison in accordance with an embodiment of the present invention;

FIG. 21 provides an example screenshot of a gain share type quote conversion for the multiple pricing comparison in accordance with an embodiment of the present invention;

FIG. 22 provides an example screenshot of a gain share type quote summary for the multiple pricing comparison in accordance with an embodiment of the present invention; and

FIGS. 23A and 23B provide examples of a computer system capable of implementing some embodiments of the present system in accordance with an embodiment of the present invention.

### DETAILED DESCRIPTION

The present invention will now be described in detail with reference to selected preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

As previously noted, the present system and methods provide enhanced tools for the negotiation of favorable deal terms in the Business to Business (B2B) environment. In some embodiments of the invention, the user may set high level dimensions for a given deal; thereby maintaining an executive level view of the deal. The system may then automatically generate line item values for the deal. These line items may be presented to the user in a deal summary for negotiation purposes.

The B2B environment has a number of unique difficulties related to properly pricing of products and services. These arise from the relatively small numbers of consumers which make traditional modeling of demand unrealistic. Thus, improving revenue and profitability in the B2B market may be a substantial hurdle for many companies. The present system addresses these problems by facilitating negotiation processes, thereby positively influencing profitability in the B2B markets.

Below are provided, in greater detail, numerous embodiments of the system and methods for top down negotiations. This discussion is divided into number of subsections for the sake of clarity. These subsections are intended to aid in the reading of the application are not limiting in nature. Thus, relevant portions of any given subsection may be applied to another subsection as is applicable.

### I. Top Down Negotiation

### A. Systems

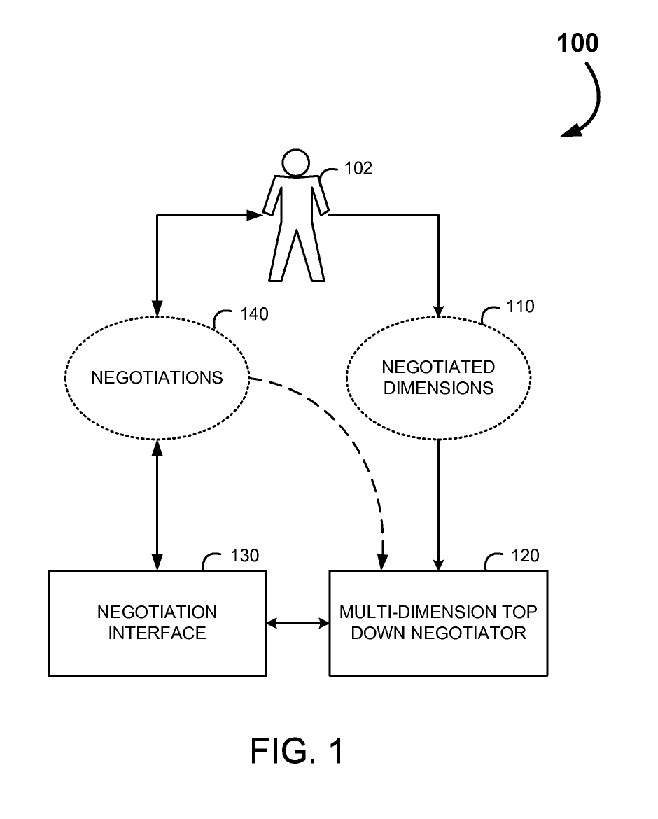

To facilitate discussion, FIG. 1 provides an example block diagram for an embodiment of the Top Down Negotiation System 100. In this figure a User 102 may be seen providing Negotiated Dimensions 110 to a Multi-dimension Top Down Negotiator 120. The Multi-dimension Top Down Negotiator 120 may be coupled to a Negotiation Interface 130. The Negotiations 140 may be performed by the User 102 with data provided by the Multi-dimension Top Down Negotiator 120 via the Negotiation Interface 130. Feedback from the Negotiations 140 may also be provided to the Multi-dimension Top Down Negotiator 120 for further refinement of the line item generation. In some embodiments, this feedback may include overriding of specific line item values generated by the Multi-dimension Top Down Negotiator 120.

The Negotiated Dimensions 110 provided by the User 102 may, in some embodiments, include providing the value of total resources, period allocation, regional distributions, skillset distributions, inflation rates and billing hours. Of course, more or fewer dimensions may also be utilized as is desirable for a given industry or deal type.

In some embodiments, not all dimensions need be supplied by the User 102. In these embodiments, unspecified dimensions may be populated with default or other viable source. For example, published indexes may be relied upon to populate inflation rate data when the User 102 fails to provide specific information for this dimension.

The dimensions provided to the Multi-dimension Top Down Negotiator 120 may be analyzed to produce a line item level breakdown of the specific deal. Overrides may be performed on these generated line items, in some embodiments. The line item data may be provided to the Negotiation Interface 130 where a deal summary is produced. This deal summary may be utilized by the User 102 or other sales force member to actively engage in a negotiation process.

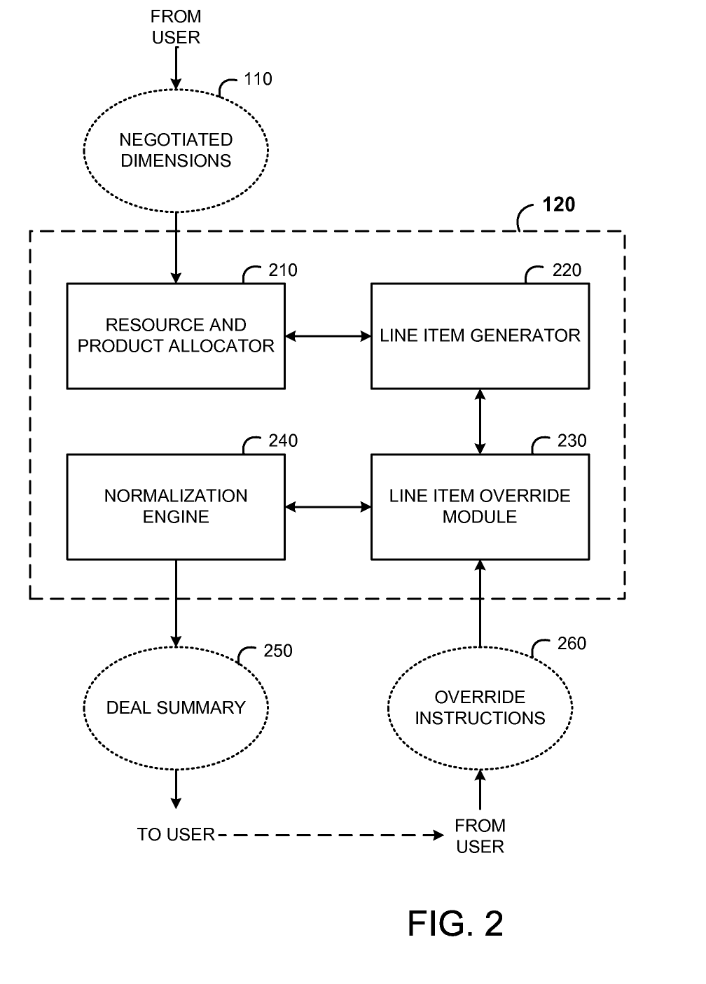

FIG. 2 provides an example block diagram of the Multi-dimension Top Down Negotiator 120. Again, Negotiated Dimensions 110 may be seen being provided by the user to the Multi-dimension Top Down Negotiator 120. Again, note that the Negotiated Dimensions 110 may include set dimension categories or user configured negotiation dimensions. In particular, any specific deal typically includes at least some unique dimensions (deal terms) which are often negotiated. These dimensions may, thus, be provided to the system, via a user configuration of the input, in order to provide an accurate generation of the line items.

In some embodiments, the Negotiated Dimensions 110 may be received by a Resource and Product Allocator 210 which applies the dimensions to specific resource categories. These resources and products may then be utilized by a Line Item Generator 220 to generate line items. Generation of line items may include divergent transformational operations on the dimensions in order to generate individual line items. In some embodiments, the transformations may be user defined, or may be defined by a system default. These system defaults may include industry specific line item models. In some cases, this may include the use of a resource model. An example of a transformation for the generation of a line item is provided below:

Total US Programmer Cost=Sum of{Annual US Programmer Cost for duration of contract}

Annual US Programmer Cost=Sum of{US Programmer Cost for different Skillsets for that year}

Yearly US Programmer Cost for a specific Skillset=Base US Hourly Programmer Billing Rate for Skillset*Inflation Rate for that year*Total Skillset Hours for that year

Base US Hourly Programmer Billing Rate for Skillset=US Programmer Billing Rate for Contract start year

Inflation Rate for first year=1

Inflation Rate for year N=Inflation Rate of Year(N−1)*(1+Inflation Rate of year N)

Total Hours for a Specific Skillset for a year=Total Programmer Hours for that year*Country percentage*Skillset percentage

Total Programmer Hours for year=#Working Days*#Hours per day for that country

Blended US Programmer Rate=Total US Programmer Cost/Total US Programmer Hours

The line items may be normalized by the Normalization Engine 240 to net present values. A Deal Summary 250 may be presented on the negotiation interface for the user. The user may utilize the deal summary for negotiation purposes, or may identify line items which are inaccurate. Inaccuracies may rise from incorrect line item transformations, or may be due to specified negotiated terms. Likewise, the user may have experienced knowledge regarding a particular deal, and it may be desirable to include this knowledge in the deal summary. In these cases, or in instances where the user desires to pursue hypothetical deal scenarios, the user may provide Override Instructions 260 to a Line Item Override Module 230. The Line Item Override Module 230 may then apply the overrides to the line items in order to update the deal summary.

Overrides of a particular line item may result in incompatibility with dimension values or other line items. For example, increasing the quantity of hours of a programmer in Bangalore may result in an increased cost associated with this programmer line item. This may cause the total cost of the deal to exceed the negotiated total resource dimension. The system may deal with such incompatibilities by automatically adjusting other line items to compensate for the override, in some embodiments. This may include reducing other programmer hours, reducing hourly rates, reducing margin, or the like. Alternatively, the system may provide a warning flag to the user of the incompatibility, and request user input to resolve the conflict.

The updated line items may then be provided to the Normalization Engine 240 for updating of the Deal Summary 250. Overriding of the Deal Summary 250 may be performed as often as desired by the user, in some embodiments.

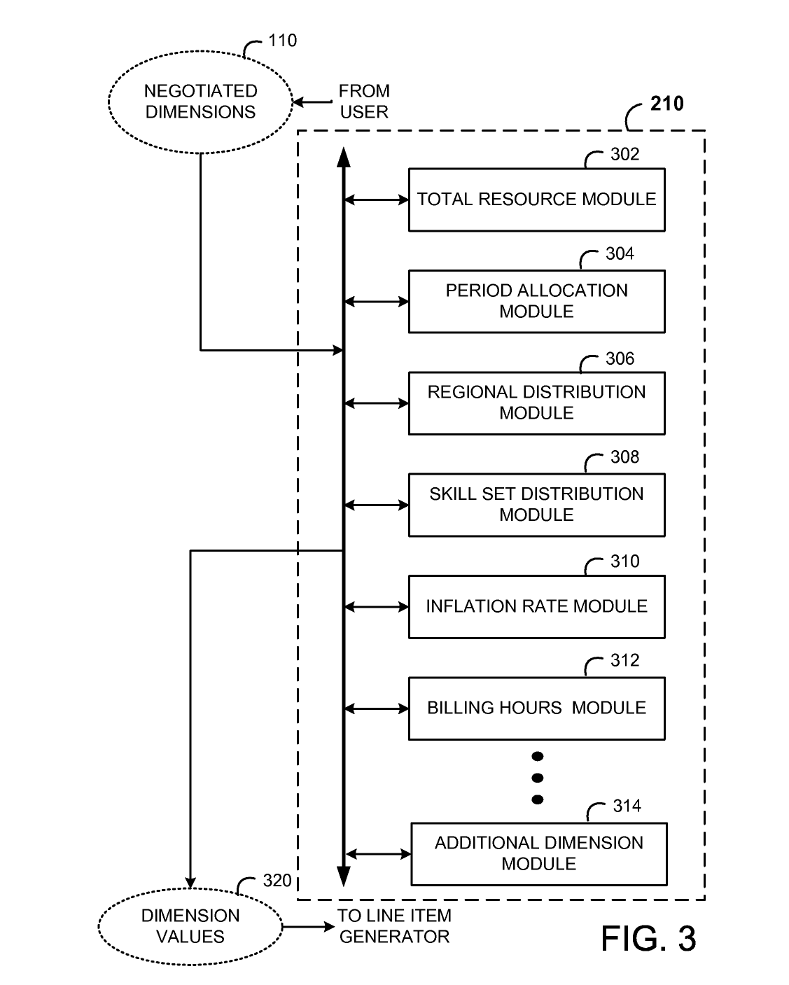

FIG. 3 provides an example block diagram of the Resource and Product Allocator 210. In some embodiments, the Negotiated Dimensions 110 is provided to the Resource and Product Allocator 210 which, as illustrated, may include one or more dimension modules. These dimension modules may be predefined, and/or user configurable. These modules may include a Total Resource Module 302, a Period Allocation Module 304, a Regional Distribution Module 306, a Skill Set Distribution Module 308, an Inflation Rate Module 310, a Billing Hours Module 312 and any other Additional Dimension Module 314. Note that this listing of example modules is entirely subject to the provided Negotiated Dimensions 110, and may be altered or configured by the user to conform to a particular negotiation.

The Total Resource Module 302 typically includes fields for total dollars and/or man-hours negotiated. Additionally, the production of particular products or services may likewise be set at the Total Resource Module 302. Likewise, a total length of time for the deal may be input at this module.

The Period Allocation Module 304 may include fields for the period of the deal, as indicated from the Total Resource Module 302. These fields may include percentage breakdown of the deal, milestone timing or other allocation. Thus, for example, in a service agreement, the services may be rendered at a split percentage across the entire period. Conversely, for other agreements, such as a systems upgrade, the deal may be skewed where the bulk of the infrastructure work is completed early in the period, and afterwards only service of the system is provided. Further, in a growing business, a particular deal may increase over time to meet the demand of the growing client.

The Regional Distribution Module 306 may include a pull down menu, or fields, for the selection of where the goods are produced and/or where the deal services are provided. Again, this breakdown is typically provided as a percentage of location where the deal is performed.

The Skill Set Distribution Module 308 indicates the required skill level (i.e., skillset) required for deal completion. Again skillset may be provided as a percentage of the entire employee requirements. Skill levels required for a given deal may vary significantly; thereby impacting wages and costs. Thus, the Skill Set Distribution Module 308 provides a convenient way for the user to indicate the general levels of skill required for deal completion.

The Inflation Rate Module 310 may rely upon data inputted in the Regional Distribution Module 306 and the period of the deal in order to generate a listing of fields for the inflation rate, over a time period in each region. The inflation rate is typically input as a percent, or other index. Additionally, inflation rates may be set by year in each region. In alternate embodiments, the time period for inflation rates may be changed to reflect the user's desires. Thus, for a short-term deal in a volatile market, the user may desire to input inflation rates on a monthly basis rather than yearly.

The Billing Hours Module 312 may utilize data garnered from the Regional Distribution Module 306 to generate a set of fields for hours worked per day by given region. The user may then input current average hours in these fields.

Further, at least one Additional Dimension Module 314 may be utilized as is desired. For example, an additional dimension may include Phases of the Project. Phases of the Project may further include Discovery, Requirements, Proof of Concept, Design, Implementation, Testing, Performance tuning, UAT, Go Live, Post Go Live and Maintenance. Thus, given a particular negotiated deal, the user may select any combination of applicable dimensions. Thus, fewer or more dimensions may be utilized, as is desirable for any given implementation of the present invention.

Once all dimensions have been input, the Dimension Values 320 may be compiled and output to the line item generator. As noted, the dimension values may be user input via a computerized interface, or may be automatically populated. Auto population may utilize default values and/or automated lookup of published values. For example, the system may be configured to automatically query an interest rate database to auto populate interest rates per region over the applicable period of time. Likewise, lookup tables for billing hours by region, industry specific skill set distributions, and additional lookup datasets may be utilized for auto population of dimension values.

### B. Methods

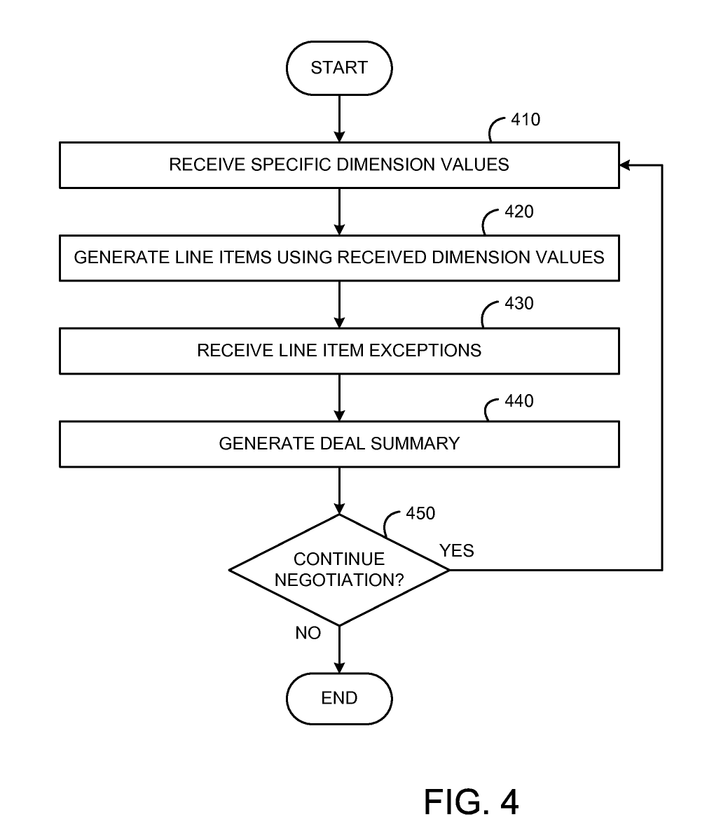

FIG. 4 provides an example flow chart for the negotiation process using the multi-dimensional top down negotiator. In this example process of one embodiment of the invention, it is assumed that an initial negotiation has been performed through which high level dimensions have been agreed upon. Conversely, the initial dimensions may be generated as hypothetical deal terms for modeling of potential deals.

These specific high level dimension values may be received at step 410. The dimensions may constitute input variables for divergent transformative functions, as outlined above. In this manner, line items may be generated, at step 420.

Line items may be displayed to the user. The user may determine that overrides to the line items are necessary. These overrides are received as line item exceptions at step 430. The line items are replaced by these exceptions. Additionally, any conflicts arising from the override may be resolved by the system. Typically, these conflicts revolve around the sum of line items no longer matching the inputted total resources dimension. Other line items must, thus, be modified to ensure all deal values match the original dimensions.

After the line items have been updated, the system may generate a deal summary, at step 440. The deal summary may be utilized by the user to facilitate deal negotiations. An inquiry is then made if the negotiations are continuing or not. Once negotiations are concluded, the process ends. However, if negotiations are ongoing, new dimension values may be agreed upon. Thus, the process may return to step 410. In this way, new deal summaries for the negotiated deals may be continually generated. Moreover, in addition to aiding the user with negotiations, the deal summaries may be generated in order to run hypothetical deal scenarios and/or for other business planning.

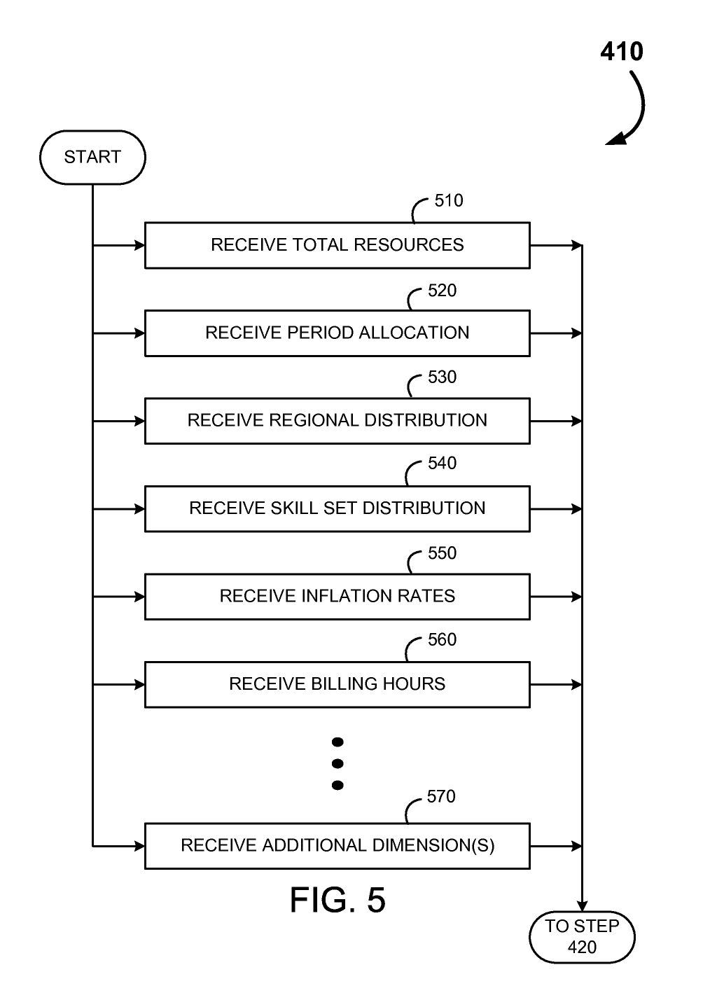

FIG. 5 provides an example flow chart for the specification of dimension values, shown generally at 410. In this process, the dimension values are received from the user, in some embodiments. Alternatively, the dimension values may be set to default values or set according to a query of a database (e.g., inflation rate data).

Also of note, in this example process the receipt of all the dimension values is illustrated as occurring in parallel. While some situations may enable the user to enter data simultaneously for each dimension (or in any order), other embodiments of the present invention may require systematic input of the dimensions. For example, it may be desirable that the user inputs regional distributions before entering the billing hours. This is because the billing hours module may configure the displayed fields to match the regional distribution, in some embodiments.

In some embodiments, the dimension values received by the system include any of total resources (step 510), period allocation (step 520), regional distribution (step 530), skill set distribution (step 540), inflation rates (step 550), billing hours (step 560), and any other additional dimensions (step 570). Detailed discussions of these dimensions may be found above in reference to FIG. 3.

Note that these dimensions are determined by the applicable negotiation; thus, fewer or more dimensions may be utilized for any given negotiation. Further, any combination of dimension types may be utilized for any given negotiation.

After the last applicable dimension is received, this process ends by progressing to step 420 of FIG. 4.

### C. Examples

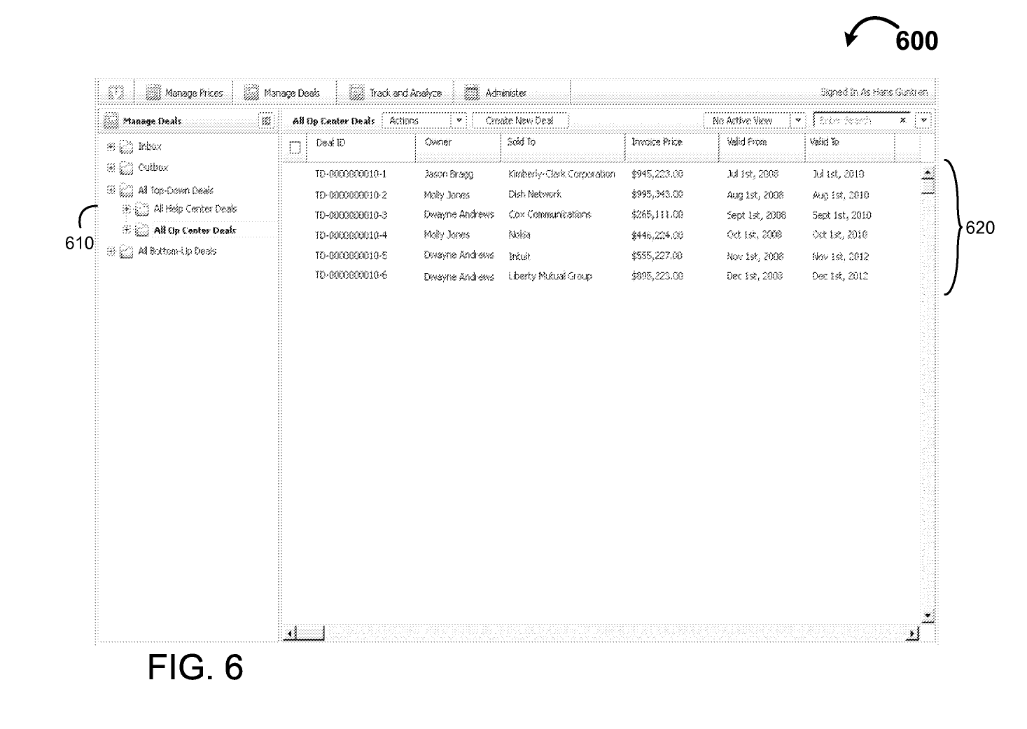

FIGS. 6-11 provide example screenshots for some embodiments of the present invention. These example screenshots are provided in a window based graphical user interface, as is commonly available on most computer systems. These embodiments of the present invention may be a preloaded application on the computer system, or may include a web accessible program. For web accessible embodiments, it may be desirable to first require authentication of the user given known authentication schemes. This may include login with a username and password, or may require more sophisticated security measures, such as certificates, and MAC address checking.

Additionally, the instant top down negotiation system may be part of a greater business management suite. Thus, in some of the example screenshots the top buttons may enable the user to navigate from one business management tool to another. Note that these figures are provided as way of example, and are not intended to limit the functionality of the present invention.

FIG. 6 provides an example screenshot of a listing of all top down deals, shown generally at 600. At the top of the screenshot may be seen the tools available in a business management suite. The “manage deals” tool is currently selected. At tree 610, the manage deals tool lists general high level categories of deals. This includes an inbox of deals, an outbox of deals, all top down deals, and all bottom up deals. The present invention is related to top down deals, and particularly with line item generation for top down deals. Thus, a category of top down deals (i.e., op center deals) is currently selected in the example screenshot.

An overview of the deals in the selected category of deals is then displayed at 620. The deal overview may include the deal ID, owner, who it was sold to, invoice price, and validity dates.

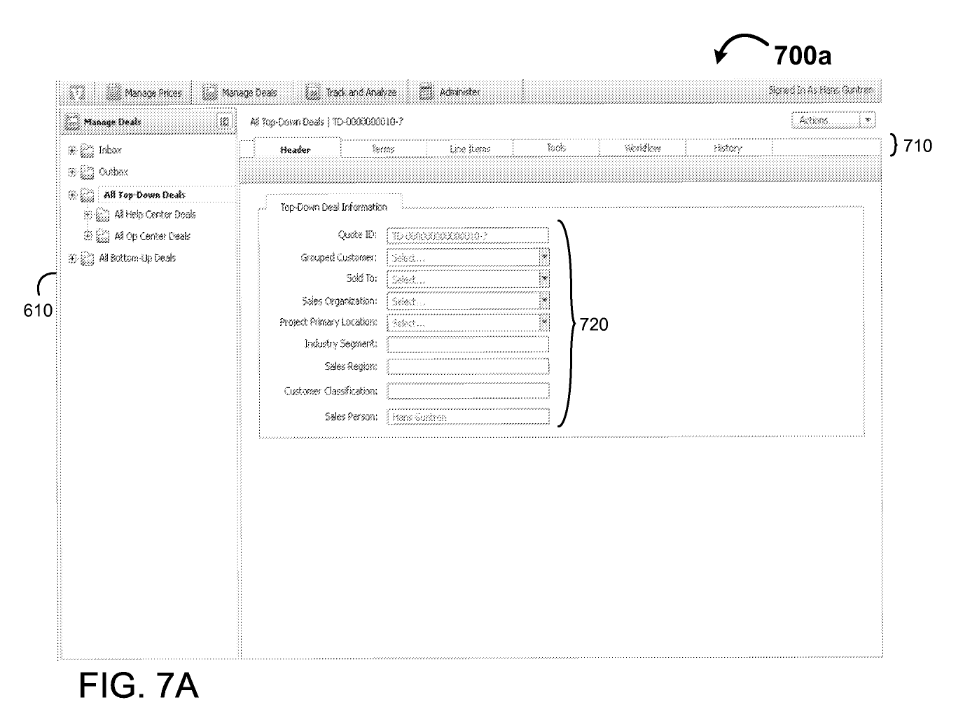

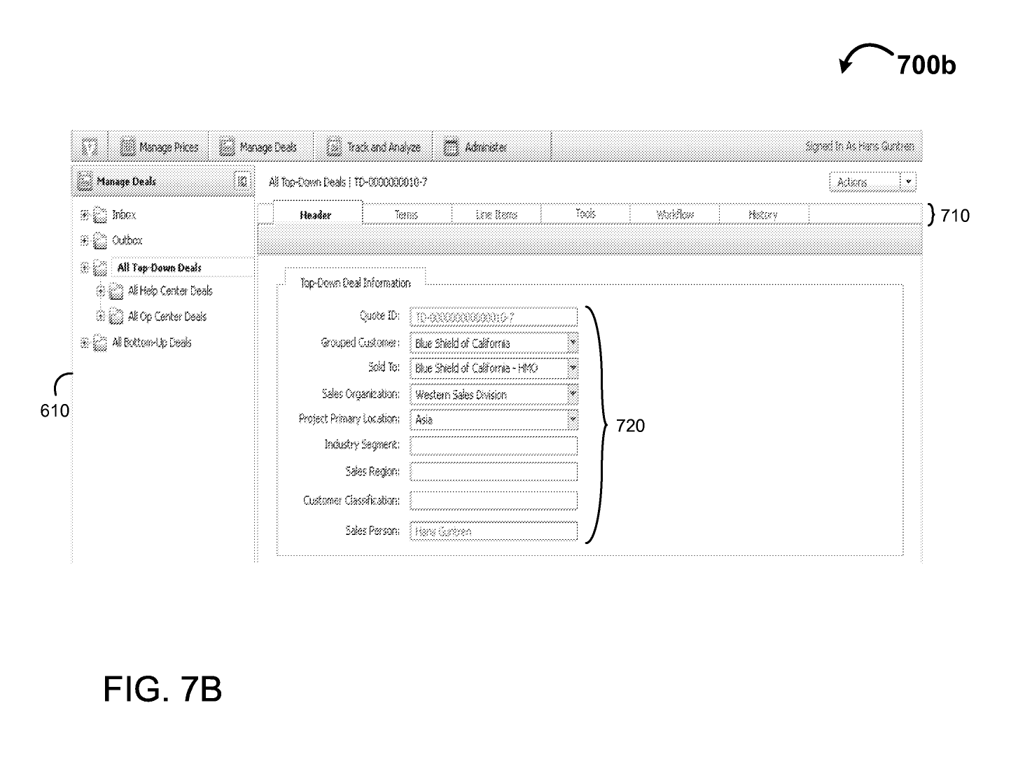

The user may select any of the deals indicated at 620. Selecting any particular deal may open the header screen for the selected deal. Header screens may be seen in FIGS. 7A and 7B.

In FIG. 7A, an unpopulated header screen is provided for a newly generated deal, shown generally at 700a. The deal includes a number of tabs, shown at 710. Currently the header tab is selected for the given deal.

The header data can be seen at 720. The current header has not yet been populated and includes fields accessible by the user to define the deal in high level terms. These header fields include the deal ID (already provided), customer, sold-to data, sales operation, primary location of the project, industry segment, customer classification and the sales person ID.

At FIG. 7B, the deal header data is seen partially filled out (at 720). Pull down menus for the required fields are used to simplify the selection process for the salesperson. After the header data has been selected, the user may continue by selecting the ‘terms’ tab at 710. ‘Terms’ are agreed upon during negotiation. The word ‘terms’ may be considered synonymous with ‘deal terms’, ‘deal dimensions’, ‘dimension terms’, or simply ‘dimensions’.

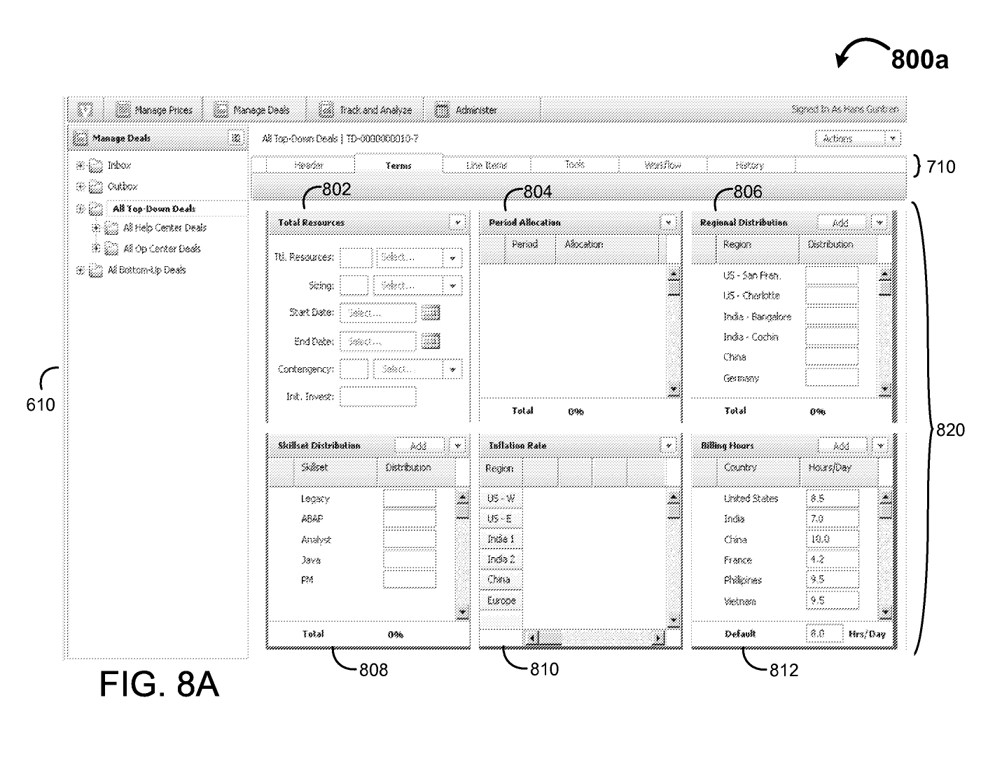

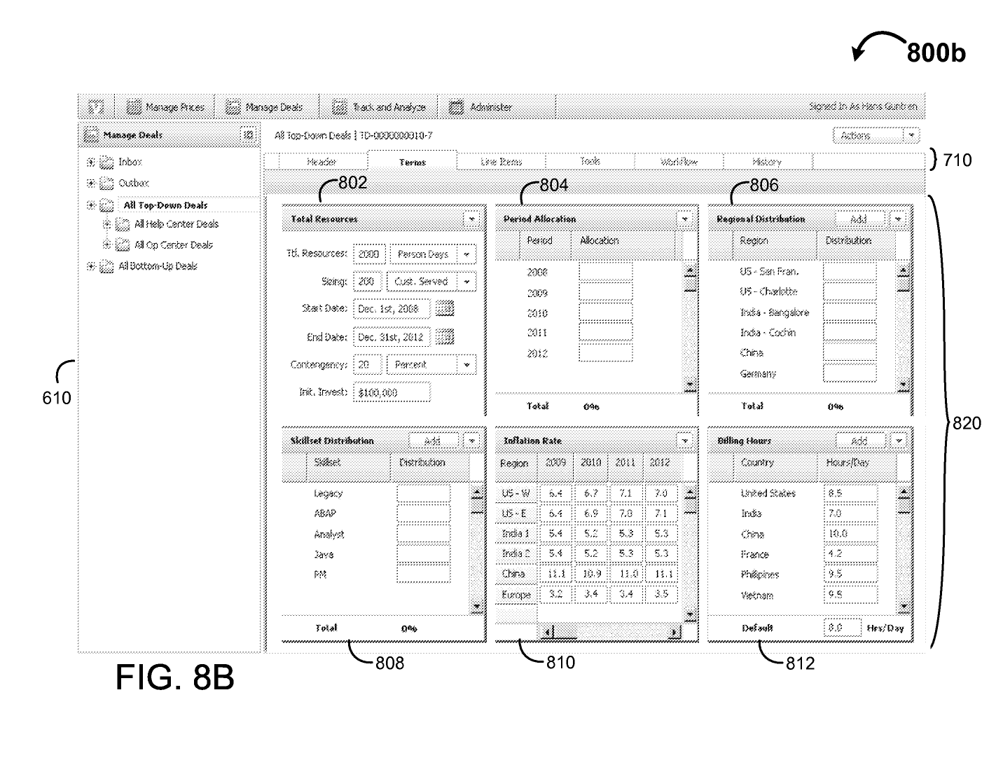

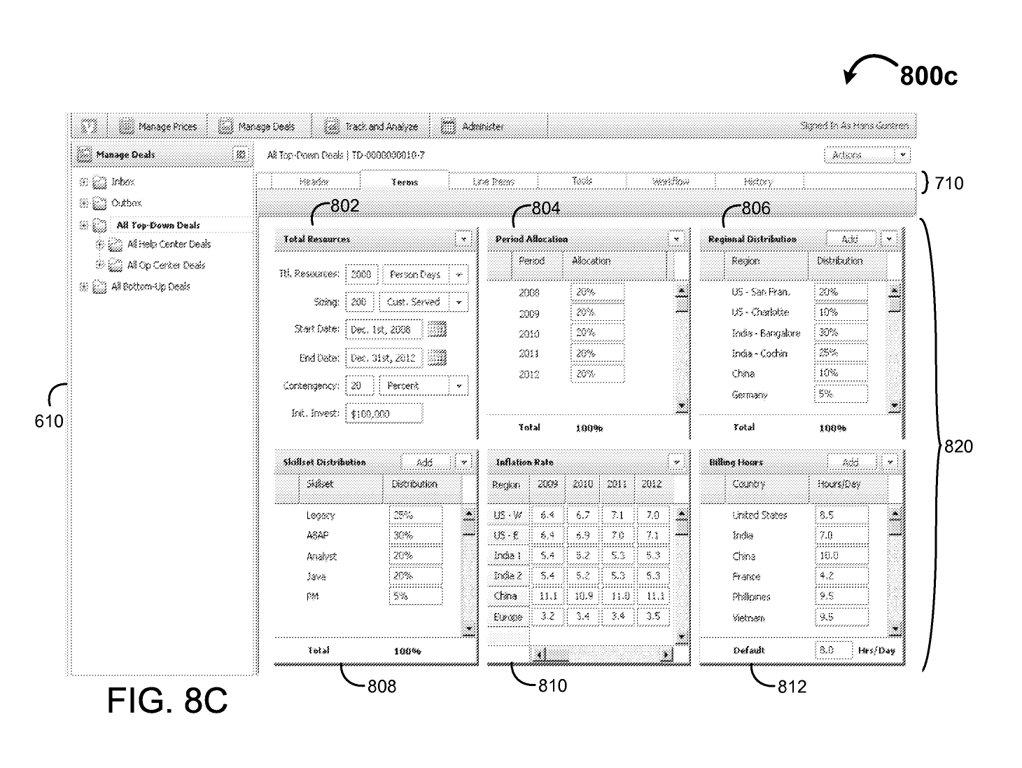

FIGS. 8A to 8C provide example screenshots of terms (dimensions) for the top down deal. FIG. 8A, at 800a, has unpopulated terms (dimensions) illustrated. Here six dimension modules are illustrated at 820. These include menus for total resources (at 802), period allocation (at 804), regional distribution (at 806), skillset distribution (at 808), inflation rates (at 810) and billing hours (at 812). As previously noted, this selection of dimension terms is purely exemplary. Other dimensions, both in number and in type, may be utilized depending upon the deal negotiations.

Some of the illustrated dimension menus have static fields, in this example screenshot. For example, the regional distribution window lists particular locations. These locations may be selected from known operating locations of the customer, which was selected in the header menu. Alternatively, a set default listing of regions may be utilized for every generated deal.

Other dimension menus are dynamic, i.e., they change in response to input into other menus. A good example of a dynamic field is period allocation. This menu requires the total deal duration, as indicated at the total resources menu, before fields are generated.

At FIG. 8B, the menu for total resources has been populated with total resources, start date and end date, as well as invoice pricing. The start and end dates are used by the period allocation menu and inflation rate menu to generate fields, in this example.

In this example figure, inflation rates for each region and across the applicable time period are populated with percentages. Likewise, billing hours by country are also populated. Billing hours indicate the number of hours spent working per day by a single employee in the given region/country. These and other fields may be populated by the user; however, operational data such as this is often automatically populated from databases. Thus, average billing hours by country may be tracked on an ongoing basis and stored in a database for retrieval by the system. Likewise, current interest rate projections are widely available.

At FIG. 8C, the remaining dimension fields are filled out. In the present example, regional distribution, period allocation and skillset distribution are all provided as percentages. The total percentage for any of these distributions is required to equal 100%, in some embodiments.

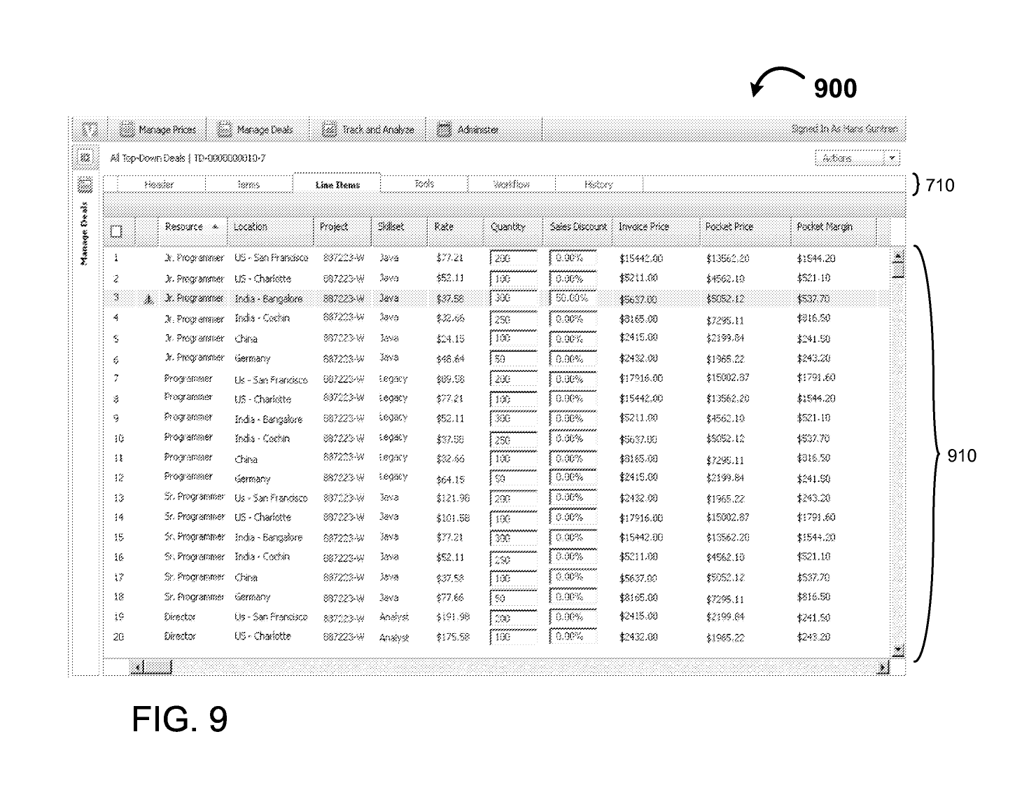

After all dimension values have been input, the user may select the next tab, at 710, for line items. The line items tab, as illustrated at FIG. 9, converts the dimensions to individual cost line items for the given deal, as indicated at 910.

Conversion of the dimensions to line items has been discussed in detail above. In general, a resource model is applied to the dimensions in order to generate the line items. The resource model may utilize divergent transformational algorithms in order to generate the line items.

The line items may include data relating to the resource type, location, project, skillset, rate, quantity, sales discount, invoice price, product price and the product margin, to name a few.

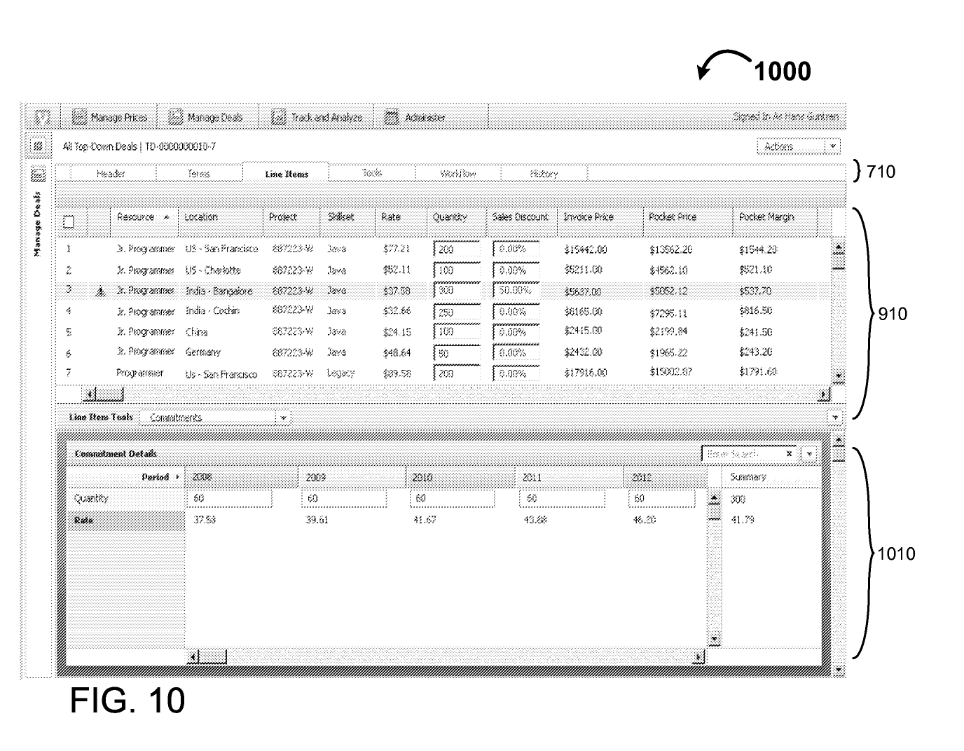

Specific line items may be selected for review and for overrides. FIG. 10 provides an example screenshot of the override tool for line items, shown generally at 1000. Here the listing of line items may still be seen at 910. Further, details of the selected line item may also be shown at 1010. Modifications to any of the fields associated with the line items may constitute an override of the given line item. For example, in this example, a sales discount of 50% has been selected for the Jr. Programmer in Bangalore.

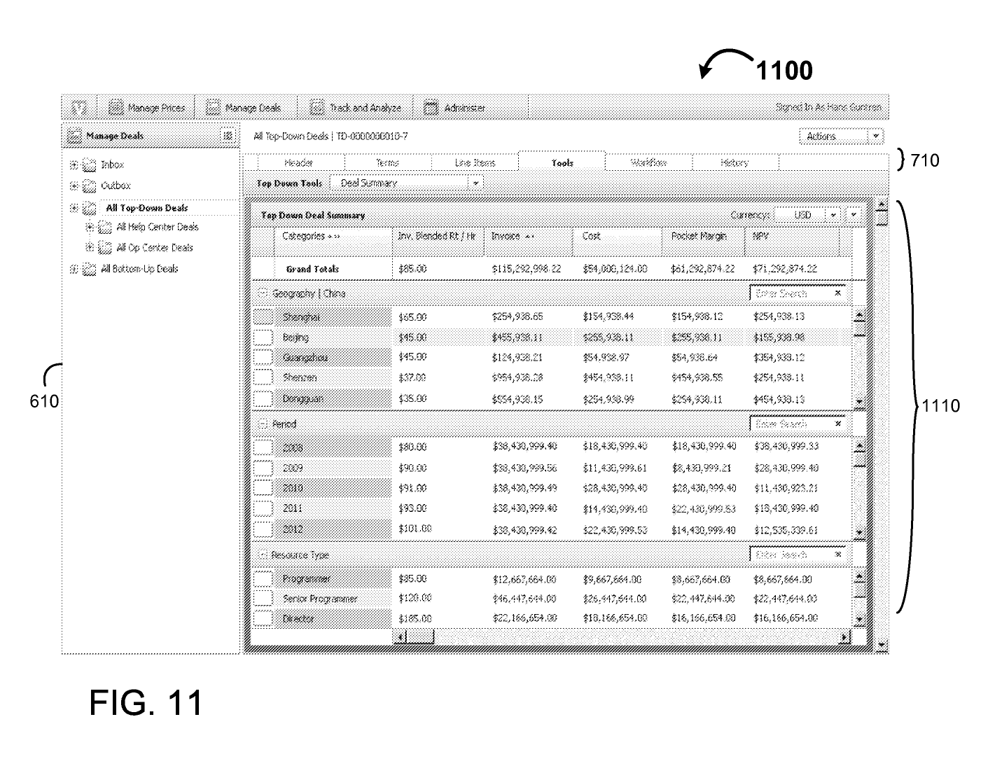

After overrides of the line items have been made, the user may select the tools tab at 710. The tools tab may include a number of tool options in a pull down menu, including the display of the deal summary. FIG. 11 provides an example screenshot of the deal summary for the top down deal, shown generally at 1100. The example deal summary (shown at 1110) may present total numbers for the deal, as well as deal breakdown by geography, time period and resource type, to name a few.

Deal summaries may be utilized for invoicing purposes and for negotiation facilitation.

### II. Pricing Methods Comparison

### A. Systems

The pricing methods comparison system utilizes time and material quotes in order to generate fixed quotes and gain share quotes. As previously discussed, time and material quotes are typically the most widely utilized quote types. These quotes itemize specific costs for resources and profit margins. The total sum of these itemized costs is the final deal quote.

Fixed price quotes, on the other hand, peg fixed payments to milestones. The most simplistic fixed price quotes state a total cost for the service with payment due upon project completion. However, staged payments and variable milestones may be also utilized in more sophisticated deals. For example, milestones may be date based, with periodic payments over a set time period. Or they may be dependent upon internal deadlines, such as after completion of a demo, or based upon number of units produced.

Lastly, the gain share quote relies on payments that are typically a percentage of gains or savings. Often this percentage is variable over a set time period. Thus, for example, if a particular service saves the purchasing company one million dollars of operation cost a year, a gain share quote system may specify that 50% of the gain is paid to the servicer in the first year, 40% the following year, and 30% thereafter on a yearly basis.

The system, after generating the different quote types, may compare the quotes to determine which pricing method generates the highest profits.

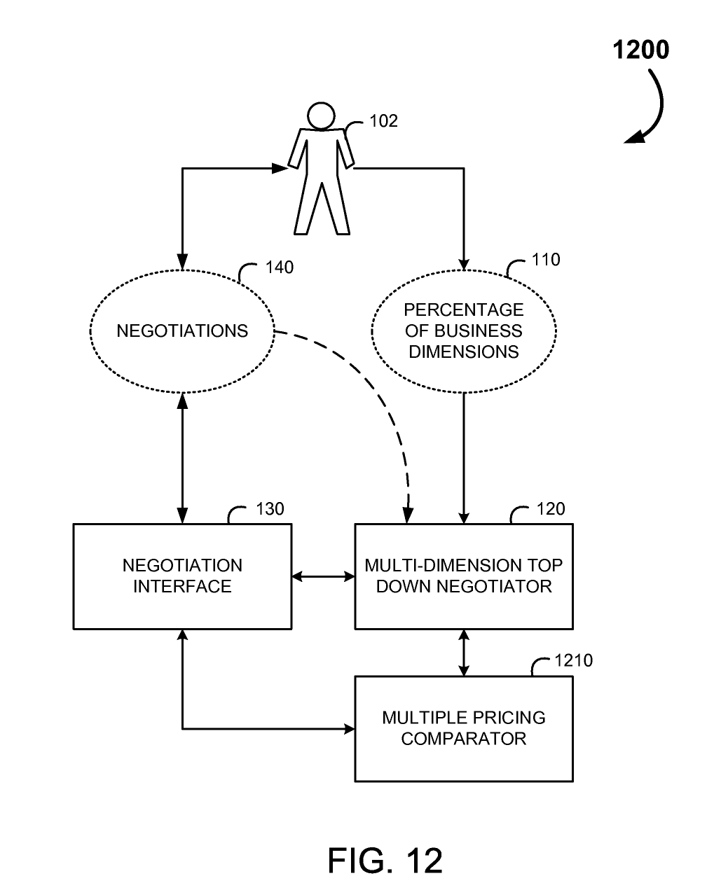

FIG. 12 provides a first example block diagram of a pricing comparison system, shown generally at 1200. In this figure, a User 102 may be seen providing Negotiated Dimensions 110 to the Multi-dimension Top Down Negotiator 120. The Multi-dimension Top Down Negotiator 120 may be coupled to the Negotiation Interface 130 as well as a Multiple Pricing Comparator 1210. The Negotiations 140 may be performed by the User 102 with data provided by the Multi-dimension Top Down Negotiator 120 via the Negotiation Interface 130. Feedback from the Negotiations 140 may also be provided to the Multi-dimension Top Down Negotiator 120 for further refinement o the line item generation. In some embodiments, this feedback may include overriding of specific line item values generated by the Multi-dimension Top Down Negotiator 120.

The dimensions provided to the Multi-dimension Top Down Negotiator 120 may be analyzed to produce a line item level breakdown of the specific deal. Overrides may be performed on these generated line items, in some embodiments. The line item data may be provided to the Negotiation Interface 130 where a deal summary is produced. This deal summary may be utilized by the User 102 or other sales force member to actively engage in a negotiation process. Additionally, the line items from the deal summary may be provided as a time and material quote to the Multiple Pricing Comparator 1210.

The Multiple Pricing Comparator 1210 may rapidly and reliably convert a time and material quote into a fixed quote and a gain share quote. A summary for the quotes may be provided to the user, as well as a suggestion of the best pricing method in order to maximize deal profits.

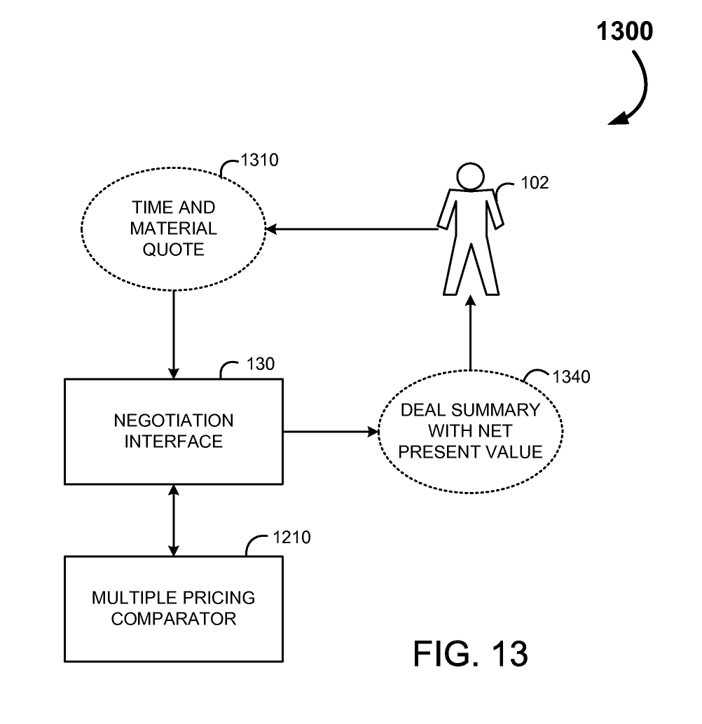

FIG. 13 provides a second example block diagram of a pricing comparison system, shown generally at 1300. In this alternate embodiment, the User 102 may provide a time and material quote 1310 directly to the Multiple Pricing Comparator 1210 via the Negotiation Interface 130. Also, the Multiple Pricing Comparator 1210 may be versatile enough to receive a time and material quote from any other viable source; including an enterprise price management system, or business management suite.

The Multiple Pricing Comparator 1210 may generate the deal summary of quotes with differing pricing methods in net present values (1340). This deal summary may be provided to the User 102 to negotiation purposes.

As noted, the Multiple Pricing Comparator 1210 may likewise determine the ‘best’ quote type. This may be performed via an optimization for profit or net revenue comparison.

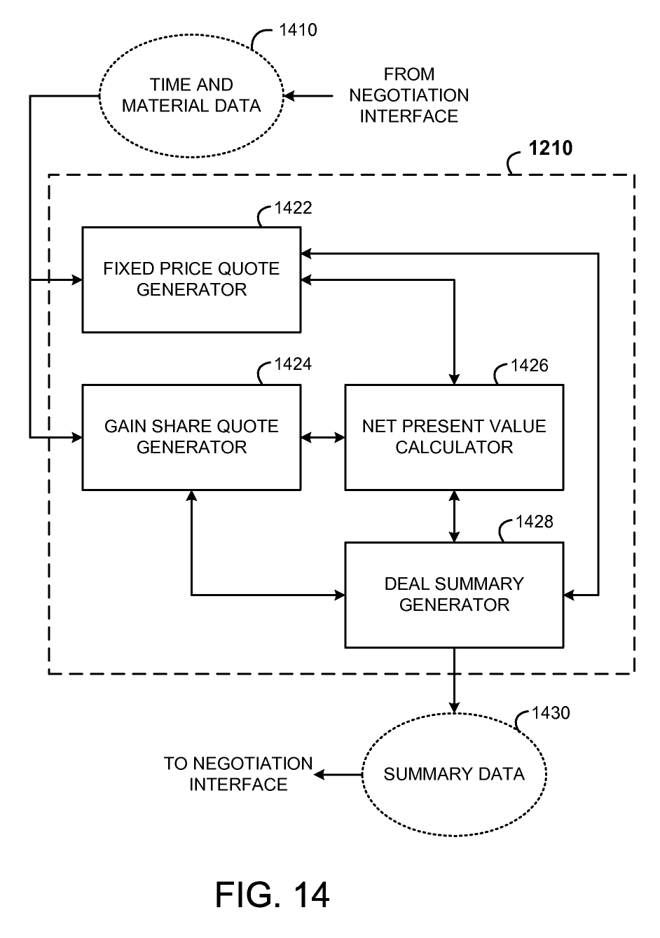

FIG. 14 provides an example block diagram of some embodiment of the Multiple Pricing Comparator 1210. Here, time and material data 1410 is shown as being provided to the Multiple Pricing Comparator 1210. The time and material data 1410 may be provided by a user through the negotiation interface, or may be received from the top down negotiator, as described above.

The Multiple Pricing Comparator 1210 may include a Fixed Price Quote Generator 1422 for the generation of the fixed price quote, and a Gain Share Quote Generator 1424 for the generation of the gain share quote. The quotes may be provided to a Net Present Value Calculator 1426 for normalization to net present values. This normalization may rely upon interest rate data for the period of time the deal is occurring over.

The raw quotes, along with normalized quotes, may then be provided to the Deal Summary Generator 1428. The Deal Summary Generator 1428 may generate summary Data Summary Data 1430 for presentation to the user via the negotiation interface. Additionally, the Deal Summary Generator 1428 may provide recommendations of which price quote maximizes profits, in some embodiments.

As previously noted, determining which method of pricing a particular deal should be negotiated with may be difficult for salespersons due to the large amount of data involved, complexity of conversion between pricing structures, and the impact of inflation. Thus, in a typical negotiation setting (or request for proposal), the most favorable pricing method may often be overlooked by the salesperson. This may lead to a loss in profits. The deal summary produced by the Multiple Pricing Comparator 1210 may facilitate the decision making process of pricing methodology. This may, ultimately, increase profitability of negotiated deals.

### B. Methods

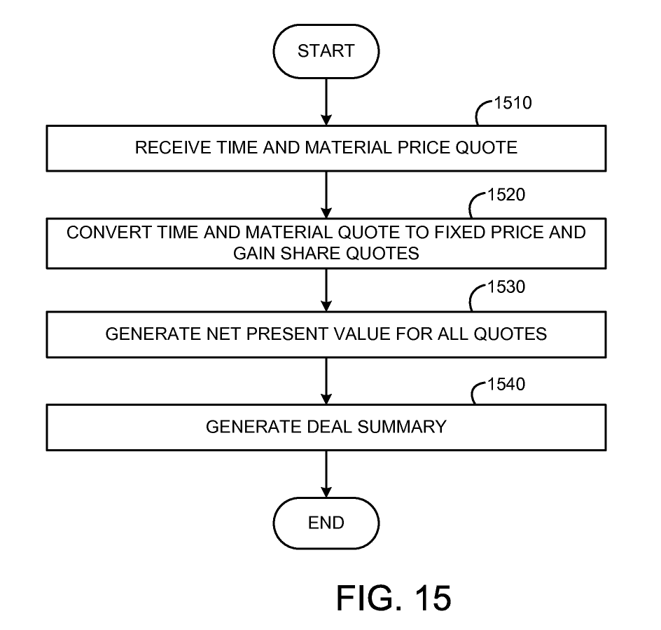

FIG. 15 provides an example flow chart for the process of comparing pricing methods in accordance with an embodiment of the present invention. The process begins at step 1510 where the time and materials quote is received. The time and materials quote may be received from the user, the top down negotiation tool or other enterprise management system.

The time and materials quote typically includes a listing of costs for resources. These costs may include bill rates, raw material costs, margins and other related resource costs.

At step 1520 the time and materials quote may be converted into a fixed price quote and a gain share quote. Conversion of the time and material quote into a fixed quote may include summing the individual line items to generate the final total cost. This total cost may then be rounded to a suitable number (i.e., to the closest thousand dollars). Likewise, adjustments may be made to the total cost, in some embodiments. Additional ways to create a fixed price quote is to start from scratch and build it up. Also, the fixed price quote may be generated by converting the gain share quote.

Conversion of the market share quote into the gain share quote involves summing costs for the given deal. This cost sum is subtracted from the existing costs for the deal, as is currently being expended by the company. The percentage(s) of gain share may then be applied to this resulting cost difference (client benefit) over the deal period in order to determine the gain share quote.

Interest rates over the deal period may then be applied to each of the quotes to determine net present value, at step 1530. This normalization may have great impact on deal profitability when involved in a volatile currency, or over a long period of time. Thus, even if a fixed price quote pays more at the completion of a five year project, a time and material quote may be more profitable if the payments are staggered over time.

The deal summary may then be generated, at step 1540; after which the process ends. The generation of the deal summary may include presenting raw quote numbers to the user, as well as normalized quote data. Additionally, in some embodiments, a selection of the most profitable deal may be provided.

### C. Examples

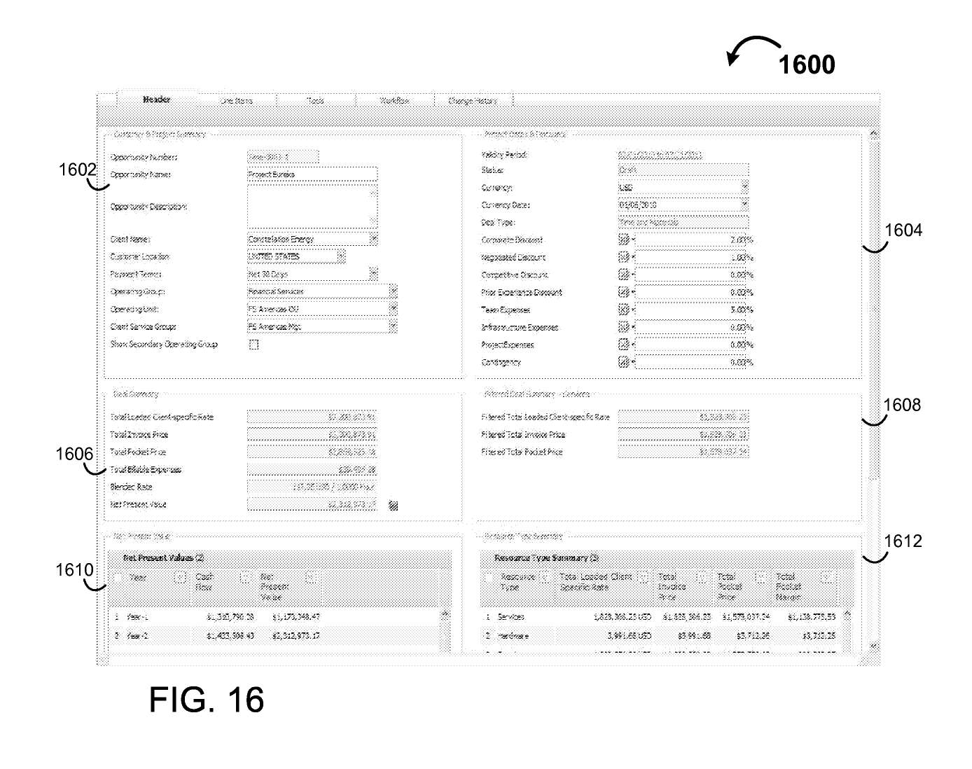

Below, in association with FIGS. 16 to 22 are example screenshots of the implementation of some embodiments of the Multiple Pricing Comparator 1210. FIG. 16 provides an example screenshot of a header for the time and materials quote of the multiple pricing comparisons, shown generally at 1600.

In this example screenshot six windows are provided. These include the consumer and project summary 1602, project dates and discounts 1604, a deal summary 1606, a filtered deal summary 1608, a net present value 1610 and a resource type summary 1612.

The project summary 1602 includes crucial information relating to the negotiating party, payment terms and operating group. The project dates and discounts 1604 window includes applicable discounts. The deal summary 1606 includes total invoice prices, expenses, billing hours and net present value.

The filtered deal summary 1608 includes price filtered for services (i.e., excluding goods). The net present value 1610 indicates cash flow and the net present value for said cash flow by year of the deal. Finally, the resource type summary 1612 lists each category of resources with its corresponding invoice price, pocket price and pocket margin.

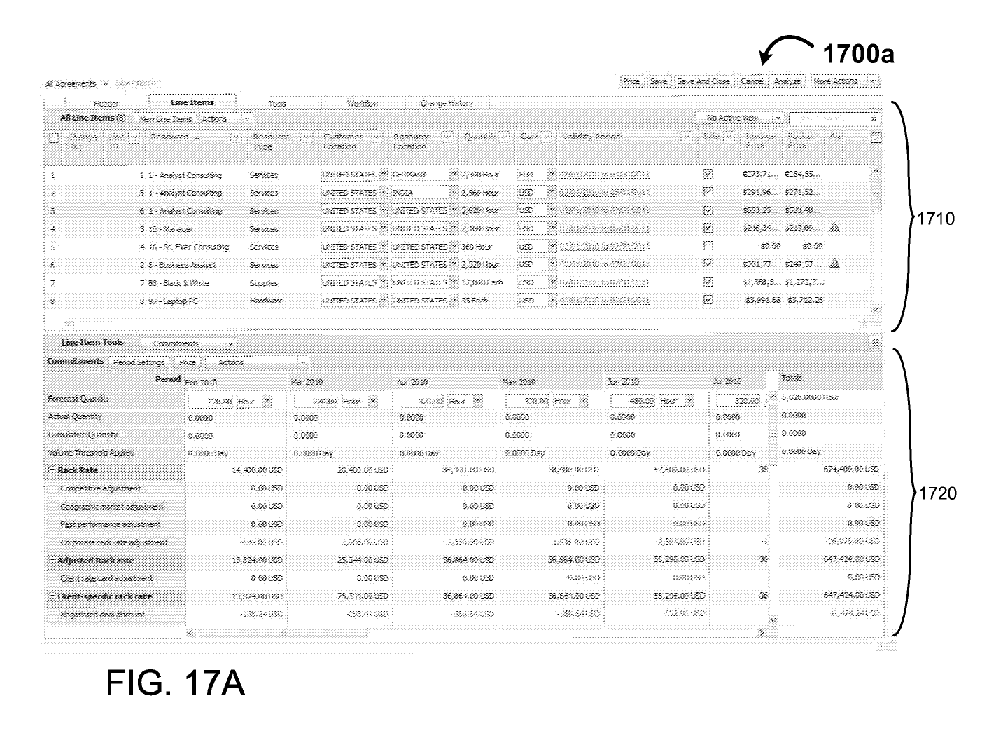

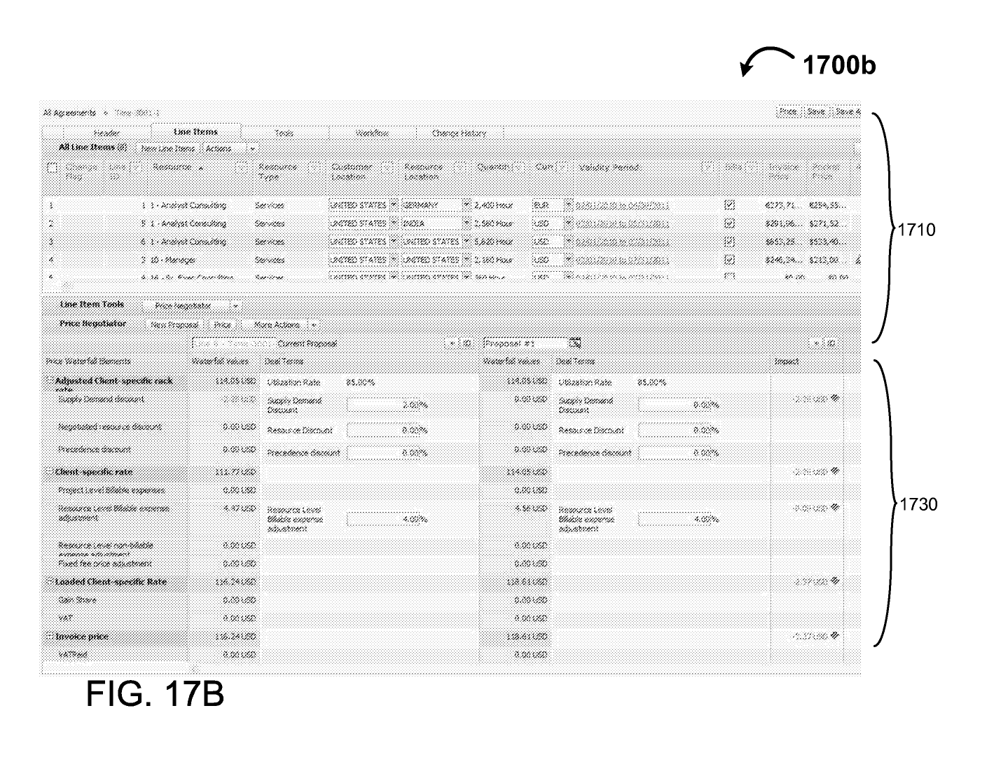

FIG. 17A provides an example screenshot of a time and material agreement line item screenshot, shown generally at 1700a. In this example screenshot, line items are listed in the window 1710. These line item values may be selected, thereby enabling access to the line item using line item tools at window 1720. Line items may be presented as including a resource name, resource type, location, quantity, currency, valid period and any other relevant information. Line item tools enable the alteration of the price and/or period of the line item.

FIG. 17B provides an example screenshot of a time and material agreement line item with price negotiator screenshot, shown generally at 1700b. In this example screenshot, line items may still be seen listed in the window 1710. However, the line items tool has been minimized in order to display the price negotiator window 1730. The price negotiator window 1730 enables the user to generate new proposal terms and specific line items.

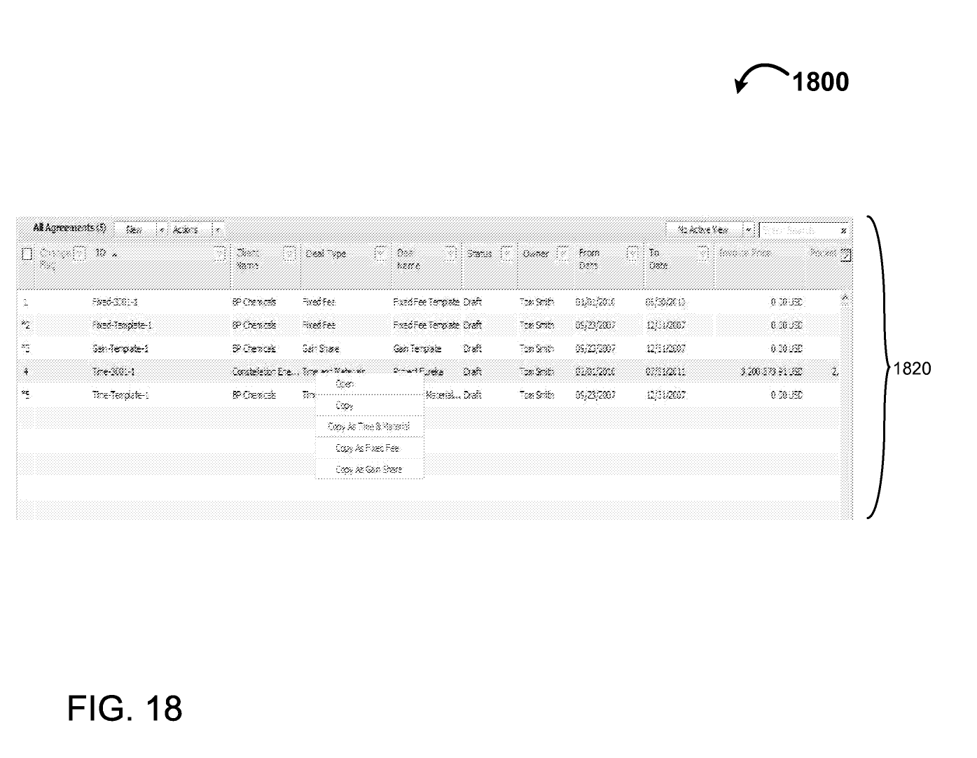

From the line items of the time and material quote, both fixed price and gain share quotes may be generated. FIG. 18 illustrates a listing of quotes, shown generally at 1800. These quotes, at 1810, are listed by ID, client, deal type, deal name status, owner (user or salesperson), from and to dates as well as prices and other relevant information. The quotes may be selected in this screen and then transformed into another quote type (i.e., fixed price quote or gain share quote).

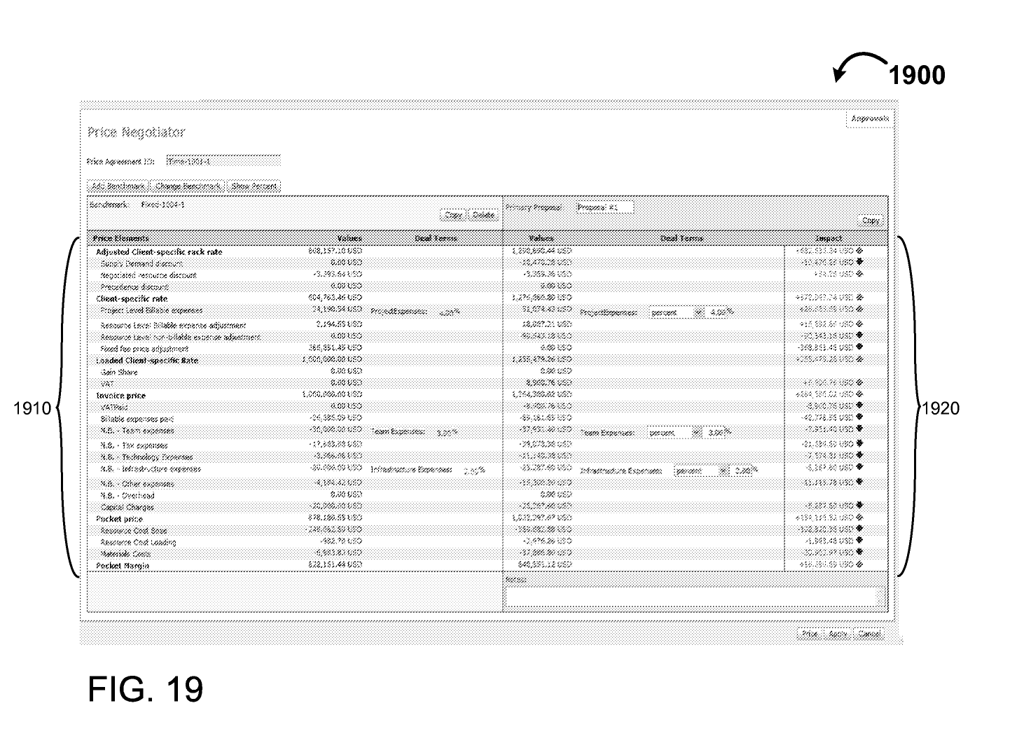

FIG. 19 illustrates a fixed price quote benchmark screenshot, shown generally at 1900. Here pricing elements are listed at 1910, along with the value of the element and deal terms. Benchmarks may be set in this screenshots. The impact of the conversion from time and materials to a fixed quote may be seen at 1920. After conversion to fixed price quote, the quote header may be displayed.

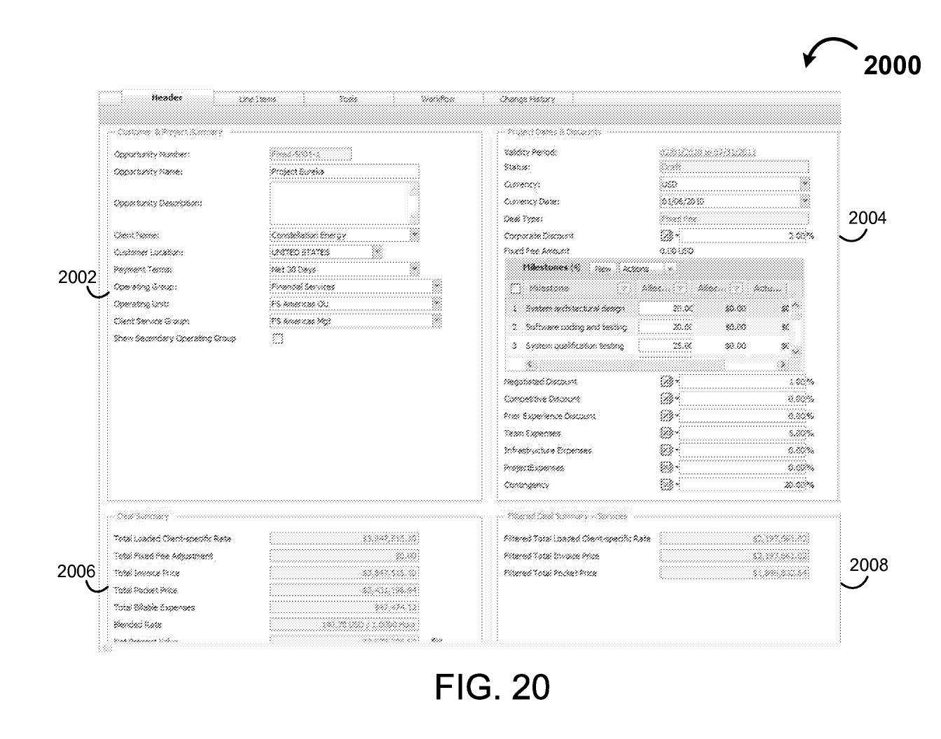

FIG. 20 provides an example screenshot of a header for the fixed type quote conversion, shown generally at 2000. In this example screenshot, four windows are provided. These include the consumer and project summary 2002, project dates and discounts 2004, a deal summary 2006, and a filtered deal summary 2008. Additionally, although not shown in this example due to sizing constraints, windows may be present for the net present value and resource type summary.

The project summary 2002 includes crucial information relating to the negotiating party, payment terms and operating group. The project dates and discounts 2004 window includes milestone information, and any applicable discounts. The deal summary 2006 includes total loaded client rate, total fixed fee agreement and other pertinent fixed fee deal information.

The filtered deal summary 2008 window displays filtered invoice prices. These prices may be filtered for services (i.e., excludes goods, etc.).

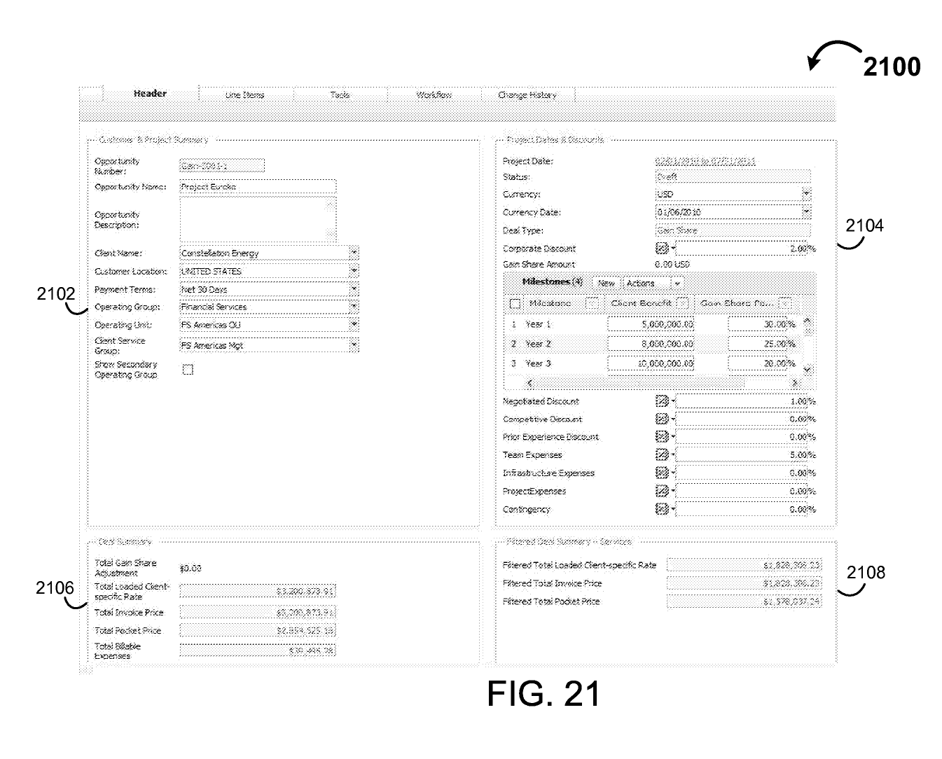

Similar to the fixed price conversion, the quote may be converted to a gain share style quote. FIG. 21 provides an example screenshot of a gain share type quote header at 2100. Like the other header types, the gain share header screen displays windows for project summary 2102, project dates and discounts 2104, a deal summary 2106, and a filtered deal summary 2108. Likewise, although not shown, windows may be present for the net present value and resource type summary.

Unlike other header types, however, the milestone field in the project dates and discounts 2104 window displays the expected client benefit on a yearly basis. Likewise, the percentage of gain share is listed.

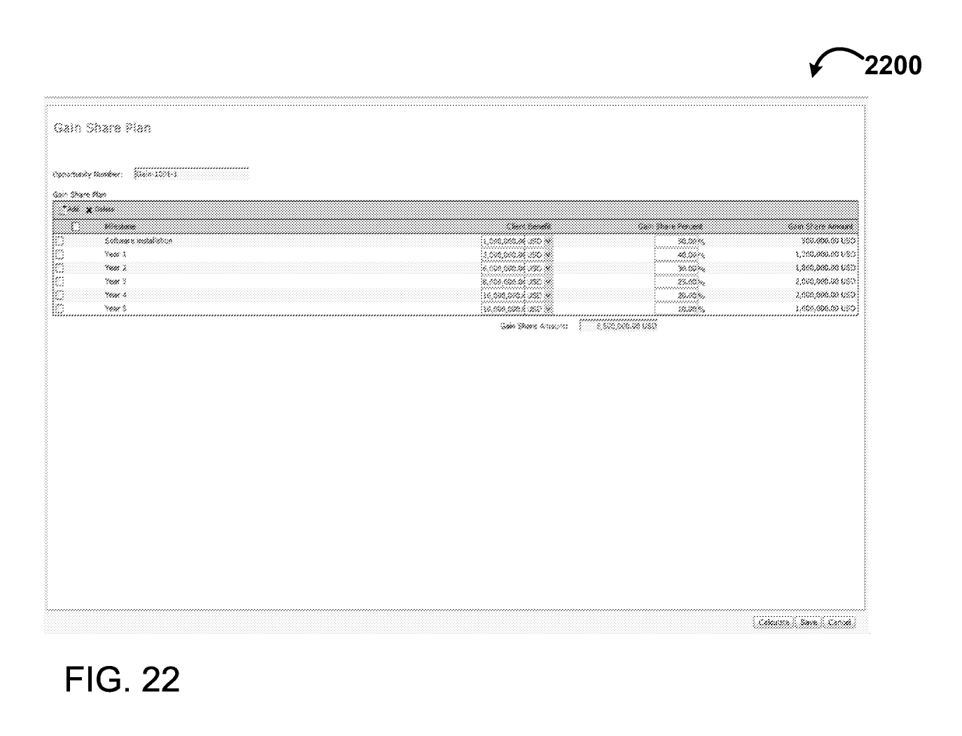

FIG. 22 provides an example screenshot of a gain share type quote summary, shown generally at 2200. Here the milestone (i.e., service benefit or yearly benefit) is listed, as is the value of client benefit, gain share percent and gain share amounts.

The converted quotes may then be presented side by side to the user to facilitate proper quote invoicing in order to produce a more profitable outcome. As noted before, the system may provide an indication of the most profitable quote type.

### III. System Implementation

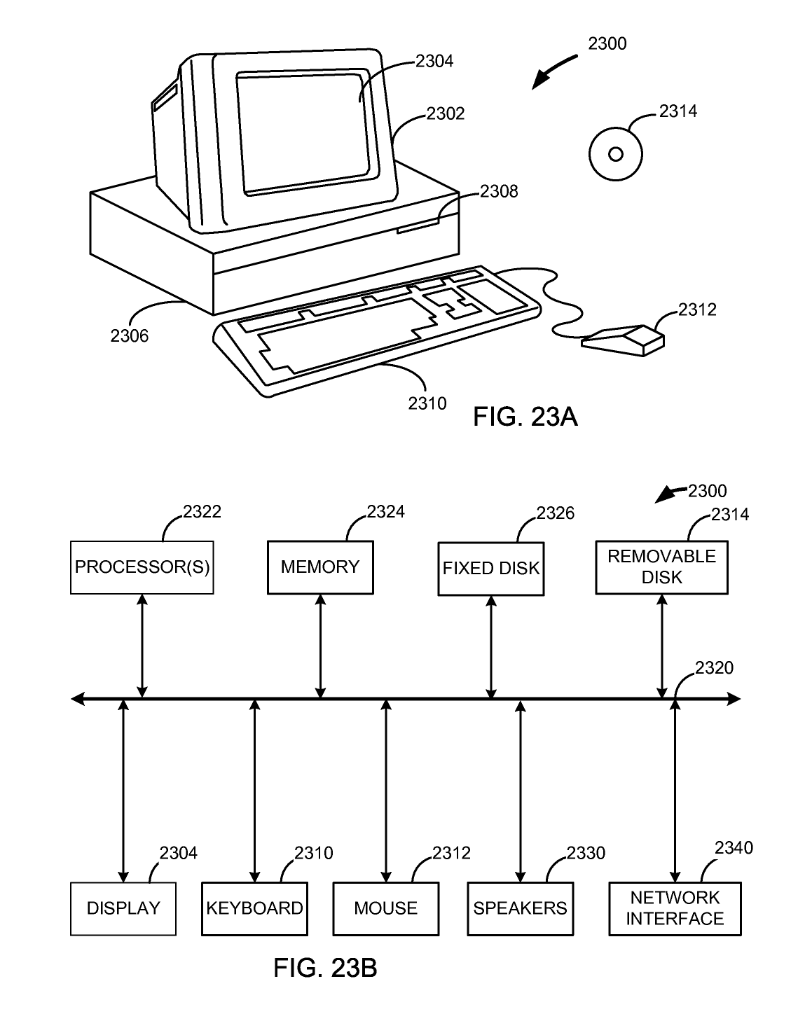

FIGS. 23A and 23B provide examples of a computer system 2300 capable of implementing some embodiments of the present system. This computer system 2300, forms part of the network 10 and is suitable for implementing embodiments of the present invention. FIG. 7A shows one possible physical form of the computer system. Of course, the computer system may have many physical forms ranging from an integrated circuit, a printed circuit board, and a small handheld device up to a huge super computer. Computer system 2300 includes a monitor 2302, a display 2304, a housing 2306, a disk drive 2308, a keyboard 2310, and a mouse 2312. Disk 2314 is a computer-readable medium used to transfer data to and from computer system 2300.

FIG. 23B is an example of a block diagram for computer system 2300. Attached to system bus 2320 are a wide variety of subsystems. Processor(s) 2322 (also referred to as central processing units, or CPUs) are coupled to storage devices, including memory 2324. Memory 2324 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 2326 is also coupled bi-directionally to CPU 2322; it provides additional data storage capacity and may also include any of the computer-readable media described below. Fixed disk 2326 may be used to store programs, data, and the like and is typically a secondary storage medium (such as a hard disk) that is slower than primary storage. It will be appreciated that the information retained within fixed disk 2326 may, in appropriate cases, be incorporated in standard fashion as virtual memory in memory 2324. Removable disk 2314 may take the form of any of the computer-readable media described below.

CPU 2322 is also coupled to a variety of input/output devices, such as display 2304, keyboard 2310, mouse 2312 and speakers 2330. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 2322 optionally may be coupled to another computer or telecommunications network using network interface 2340. With such a network interface, it is contemplated that the CPU might receive information from the network, or might output information to the network in the course of performing the above-described method steps. Furthermore, method embodiments of the present invention may execute solely upon CPU 2322 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

In sum, systems and methods for multidimensional top down price negotiations are provided. While a number of specific examples have been provided to aid in the explanation of the present invention, it is intended that the given examples expand, rather than limit the scope of the invention. Although sub-section titles have been provided to aid in the description of the invention, these titles are merely illustrative and are not intended to limit the scope of the present invention.

While the system and methods has been described in functional terms, embodiments of the present invention may include entirely hardware, entirely software or some combination of the two. Additionally, manual performance of any of the methods disclosed is considered as disclosed by the present invention.

While this invention has been described in terms of several preferred embodiments, there are alterations, permutations, modifications and various substitute equivalents, which fall within the scope of this invention. It should also be noted that there are many alternative ways of implementing the methods and systems of the present invention. It is therefore intended that the following appended claims be interpreted as including all such alterations, permutations, modifications, and various substitute equivalents as fall within the true spirit and scope of the present invention.

What is claimed is:

1. A computer implemented method for generating a deal summary, wherein the deal summary facilitates negotiation of a substantially customized goods and services deal, the method comprising:
receiving at least one negotiated deal dimension;
generating time and material line items using the at least one received negotiated deal dimension, wherein the generation of the time and material line items includes applying resource models to the at least one negotiated deal dimension;
receiving at least one time and material line item override;
updating the time and material line items by including the at least one override; and
generating a customized deal summary using the updated time and material line items.

2. The method as recited in claim 1, wherein the at least one negotiated deal dimension includes at least one of total resources, period allocation, regional distribution, skill set distribution, inflation rates, and billing hours.

3. The method as recited in claim 1, wherein at least one of the at least one negotiated deal dimension is received from a user.

4. The method as recited in claim 3, wherein at least one of the at least one negotiated deal dimension is set to a default value.

5. The method as recited in claim 1, further comprising normalizing the deal summary to present monetary value to facilitate comparisons.

6. The method as recited in claim 1, wherein the updating the line items further includes recalculating other time and material line items affected by the at least one override.

7. The method as recited in claim 1, wherein the deal summary displays at least one of a blended rate per hour, an income, a cost, a product margin, and a net present value.

8. The method as recited in claim 7, wherein the deal summary is broken down by geography, period and resource type.

9. The method as recited in claim 1, further comprising receiving an updated at least one negotiated deal dimension.

10. The method as recited in claim 9, further comprising regenerating the time and material line items using the updated at least one negotiated deal dimension.

11. A system for generating a deal summary, wherein the deal summary facilitates negotiation of a substantially customized goods and services deal, the system comprising:
an allocator configured to receive at least one negotiated deal dimension;
a line item generator, including a processor, configured to generate time and material line items using the received at least one negotiated deal dimension, wherein the generation of the time and material line items includes applying resource models to the at least one negotiated deal dimension;
a line item override module configured to receive at least one time and material line item override, and wherein the line item override module is further configured to update the time and material line items by including the at least one override; and
a summarizer configured to generate a customized deal summary using the updated time and material line items.

12. The system for generating a deal summary of claim 11, wherein the at least one negotiated deal dimension includes at least one of total resources, period allocation, regional distribution, skill set distribution, inflation rates, and billing hours.

13. The system for generating a deal summary of claim 11, wherein at least one of the at least one negotiated deal dimension is received from a user.

14. The system for generating a deal summary of claim 13, wherein the allocator is further configured to set at least one of the at least one negotiated deal dimension to a default value.

15. The system for generating a deal summary of claim 11, further comprising a normalization engine configured to normalize the deal summary to present monetary value to facilitate comparisons.

16. The system for generating a deal summary of claim 11, wherein updater configured to update the time and material line items further includes recalculating other time and material line items affected by the at least one override.

17. The system for generating a deal summary of claim 11, wherein the deal summary displays at least one of a blended rate per hour, an income, a cost, a product margin, and a net present value.

18. The system for generating a deal summary of claim 17, wherein the deal summary is broken down by geography, period and resource type.

19. The system for generating a deal summary of claim 11, wherein the allocator is further configured to receive an updated at least one negotiated deal dimension.

20. The system for generating a deal summary of claim 19, wherein the line item generator is further configured to regenerate the time and material line items using the updated at least one negotiated deal dimension.
